(19) United States
(12) Patent Application Publication
(10) Pub. No.: US 2011/0141658 A1
(43) Pub. Date: Jun. 16, 2011

(54) MULTILAYER CERAMIC CAPACITOR

(75) Inventors: Eun Sang NA, Yongin (KR); Doo Young Kim, Yongin (KR); Byung Gyun Kim, Jinhae (KR); Hyun Tae Kim, Seoul (KR); Kyoung Jin Jun, Siheung (KR); Mi Young Kim, Suwon (KR); Hye Young Choi, Suwon (KR)

(73) Assignee: SAMSUNG ELECTRO-MECHANICS CO.,LTD.

(21) Appl. No.: 12/852,254

(22) Filed: Aug. 6, 2010

(30) Foreign Application Priority Data
Dec. 10, 2009 (KR) 10-2009-0122194

(51) Int. Cl. H01G 4/06

(52) U.S. Cl. 361/321.2

(57) ABSTRACT

Disclosed is a multilayer ceramic capacitor. The multilayer ceramic capacitor includes a sintered ceramic body, a plurality of first internal electrodes and a plurality of second internal electrodes formed inside the sintered ceramic body, the first and second internal electrodes having ends alternately and respectively exposed to side surfaces of the sintered ceramic body, and first and second external electrodes formed on the side surfaces of the ceramic body and electrically connected to the first and second internal electrodes, the first and second external electrodes each including a plurality of pores with an average pore size of 2 μm to 5 μm and having a porosity of 2% to 10%.

### CROSS-REFERENCE TO RELATED APPLICATIONS

This application claims the priority of Korean Patent Application No. 10-2009-122194 filed on Dec. 10, 2009, in the Korean Intellectual Property Office, the disclosure of which is incorporated herein by reference.

### BACKGROUND OF THE INVENTION

1. Field of the Invention

The present invention relates to a multilayer ceramic capacitor, and more particularly, to a multilayer ceramic capacitor capable of having a high level of reliability by preventing the permeation of plating solution and moisture and the occurrence of cracking caused by warpage (hereinafter “warpage cracking”).

2. Description of the Related Art

In general, electronic components using a ceramic material, such as capacitors, inductors, piezoelectric devices, varistors or thermistors, include a ceramic body formed of a ceramic material, internal electrodes provided inside the ceramic body, and external electrodes installed on the surface of the ceramic body.

Multilayer ceramic capacitors among such ceramic electronic components include a plurality of laminated dielectric layers, internal electrodes interleaved with the dielectric layers, and external electrodes electrically connected to the internal electrodes.

Multilayer ceramic capacitors are being widely used as a part of mobile communications devices, such as computers, personal digital assistants (PDA) and mobile phones, due to their small size, high capacity and ease of mounting.

Recently, as electronic products have become compact and multi-functional, chip components have also tended to become compact and highly functional. Following this trend, a multilayer ceramic capacitor is required to be smaller than ever before, but to have a high capacity.

As for a general method of manufacturing a multilayer ceramic capacitor, ceramic green sheets are manufactured and a conductive paste is printed on the ceramic green sheets to thereby form internal electrode layers. Tens to hundreds of such ceramic green sheets, provided with the internal electrode layers, are then laminated to thereby produce a green ceramic laminate. Thereafter, the green ceramic laminate is pressed at high pressure and high temperature and subsequently cut into green chips. Thereafter, the green chip is subjected to plasticizing, firing and polishing processes, and external electrodes are then formed thereon, thereby completing a multilayer ceramic capacitor.

The multilayer ceramic capacitor is used while mounted on a wiring board. For this mounting, the surface of the external electrodes may be plated with, for example, nickel (Ni), tin (Sn) or the like.

When the multilayer ceramic capacitor is mounted on the wiring board by using soldering or when the wiring board mounted with the multilayer ceramic capacitor is cut, thermal impact and shear stress are applied to the multilayer ceramic capacitor. The thermal impact and shear stress may cause warpage cracking in the multilayer ceramic capacitor.

### SUMMARY OF THE INVENTION

An aspect of the present invention provides a multilayer ceramic capacitor having a high level of reliability by controlling the density of external electrodes.

According to an aspect of the present invention, there is provided a multilayer ceramic capacitor including: a sintered ceramic body; a plurality of first internal electrodes and a plurality of second internal electrodes formed inside the sintered ceramic body, the first and second internal electrodes having ends alternately and respectively exposed to side surfaces of the sintered ceramic body; and first and second external electrodes formed on the side surfaces of the ceramic body and electrically connected to the first and second internal electrodes, the first and second external electrodes each including a plurality of pores with an average pore size of 2 μm to 5 μm and having a porosity of 2% to 10%.

The first and second external electrodes may include a conductive metal having an average particle size of 0.1 μm to 3 μm.

The first and second external electrodes may include at least one conductive metal selected from the group consisting of copper, nickel and silver.

The multilayer ceramic capacitor may further include: a nickel plating layer formed on the first and second external electrodes; and a tin plating layer formed on the nickel plating layer.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view illustrating a multilayer ceramic capacitor according to an exemplary embodiment of the present invention; and

FIG. 2 is a schematic cross-sectional view taken along line I-I′ of FIG. 1, illustrating the multilayer ceramic capacitor.

### DETAILED DESCRIPTION OF THE PREFERRED EMBODIMENT

Exemplary embodiments of the present invention will now be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the thicknesses of layers and regions are exaggerated for clarity. Like reference numerals in the drawings denote like elements.

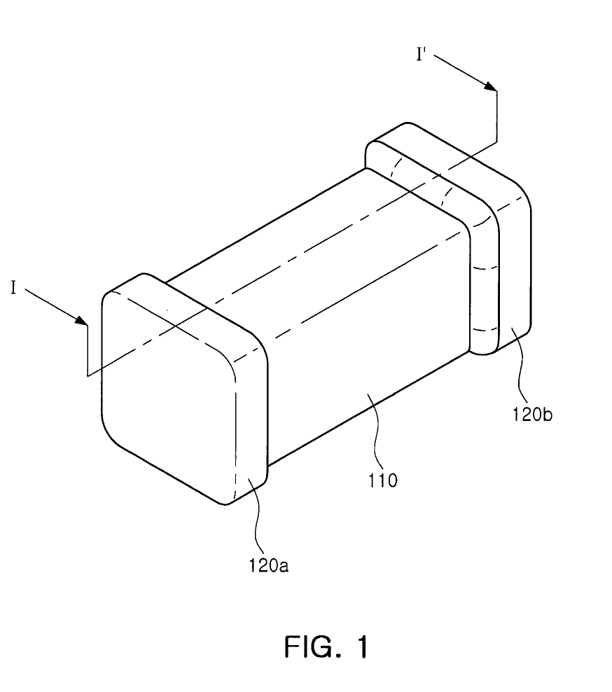

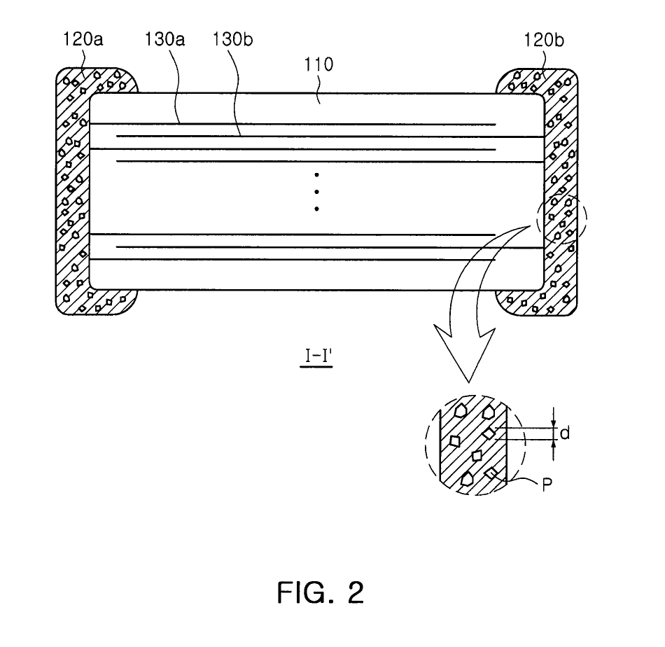

FIG. 1 is a schematic perspective view illustrating a multilayer ceramic capacitor according to an exemplary embodiment of the present invention. FIG. 2 is a schematic cross-sectional view taken along line I-I′ of FIG. 1, illustrating the multilayer ceramic capacitor.

Referring to FIGS. 1 and 2, a multilayer ceramic capacitor, according to this exemplary embodiment of the present invention, includes a sintered ceramic body 110, first and second internal electrodes 130a and 130b formed inside the sintered ceramic body 110, and first and second external electrodes 120a and 120b electrically connected to the first and second internal electrodes 120a and 120b.

The sintered ceramic body 110 is obtained by laminating a plurality of ceramic dielectric layers and then sintering them. The adjacent dielectric layers are integrated to the extent that the boundary therebetween is unidentifiable.

The ceramic dielectric layers may be formed of a ceramic material with a relatively high dielectric constant, but they are not limited thereto. For example, the ceramic material may utilize a barium titanate (BaTiO₃)-based material, a lead complex perovskite-based material, or a strontium titanate (SrTiO₃)-based material.

In the process of laminating the plurality of dielectric layers, the first and second internal electrodes 130a and 130b are interleaved with the dielectric layers. Through a sintering process, the first and second internal electrodes 130a and 130b are formed inside the sintered ceramic body 110.

The first and second internal electrodes 130a and 130b are paired as having opposite polarities. Those first and second internal electrodes 130a and 130b oppose one another in a lamination direction of the dielectric layers, and are electrically insulated from each other by the dielectric layers.

The ends of the first and second internal electrodes 130a and 130b are alternately and respectively exposed to both side surfaces of the sintered ceramic body 110. In detail, one set of ends of the first internal electrode 130a are exposed to one side surface of the sintered ceramic body 110, and the other set of ends of the second internal electrode 130b are exposed to the other side surface of the sintered ceramic body 110. The ends of the first and second internal electrodes 130a and 130b exposed to the side surfaces of the sintered ceramic body 110 are electrically connected to the first and second external electrodes 120a and 120b, respectively.

When a predetermined voltage is applied to the first and second external electrodes 120a and 120b, electric charges are accumulated between the first and second internal electrodes 130a and 130b opposing each other. Here, the capacitance of a multilayer ceramic capacitor is in proportion to the area of the first and second internal electrodes 130a and 130b opposing each other.

The first and second internal electrodes 130a and 130b are formed of a conductive metal, and may utilize, for example, Ni or a Ni alloy. The Ni alloy may contain Mn, Cr, Co or Al as well as Ni.

The first and second external electrodes 120a and 120b each contain a plurality of pores P having an average pore size d of 2 μm to 5 μm, and the porosity thereof ranges from 2% to 10%. The porosity may be defined as a ratio of the total sectional area of the plurality of pores with respect to the sectional area of the external electrode.

The first and second external electrodes 120a and 120b, according to this exemplary embodiment of the present invention, may include a conductive metal having an average particle size of 0.1 μm to 3 μm. The conductive metal may utilize copper, nickel, silver, or a mixture thereof.

Typically, a densified electrode improves reliability since the permeation of plating solution and moisture can be blocked. However, this densification makes it difficult to release gas and binder components generated at high temperature during an electrode firing process, thereby causing blister defects. In addition, a multilayer ceramic capacitor, when mounted on a board, may experience warpage cracking due to thermal impact and shear stress applied thereto at the time of mounting.

However, according to this exemplary embodiment of the present invention, the first and second external electrodes 120a and 120b contain a plurality of pores P having an average pore size of 2 μm to 5 μm and have a porosity of 2% to 10%. As the density of the first and second external electrodes 120a and 120b is controlled in this manner, the permeation of plating solution and moisture is blocked to thereby suppress warpage cracking. Furthermore, since gas and binder components are effectively released during the process of firing the external electrodes, blister occurrence can be reduced.

An average pore size of less than 2 μm and a porosity of less than 2% may be contributive to suppressing the permeation of plating solution and moisture, but hinder the release of binder components in the process of firing the external electrodes, thereby causing blister defects and warpage cracking.

Also, an average pore size exceeding 5 μm and a porosity exceeding 10% may lower blister and warpage-crack occurrence rates, but result in the permeation of plating solution and moisture, thereby impairing reliability.

A nickel (Ni) plating layer (not shown) and a tin (Sn) plating layer (not shown) formed on the Ni plating layer may be further provided on the first and second external electrodes 120a and 120b. The Ni plating layer and the Sn plating layer improve an electrical connection between a wiring board and a conductive land. The Ni plating layer and the Sn plating layer may be formed by using a wet plating method, such as electro-plating or the like.

According to this exemplary embodiment of the present invention, the density of the first and second external electrodes 120a and 120b is controlled such that the permeation of plating solution is prevented during the wet plating process. Thus, the reliability of the multilayer ceramic capacitor is prevented from deteriorating.

A method of manufacturing a multilayer ceramic capacitor, according to an exemplary embodiment of the present invention, will now be described.

First, a plurality of ceramic green sheets are prepared. The ceramic green sheets are manufactured by mixing ceramic particles, a binder and a solvent to thereby produce a slurry, and then making the slurry into sheets having a thickness of a few micrometers by using a doctor blade method.

An internal electrode paste (i.e., a paste for the formation of internal electrodes) is applied on the surfaces of the ceramic green sheets to thereby form first and second internal electrode patterns. The first and second internal electrode patterns may be formed by using a screen printing method. The internal electrode paste is formed by dispersing powder, formed of Ni or a Ni alloy, in an organic binder and an organic solvent and making a resultant material into a paste. The Ni alloy may contain Mn, Cr, Co or Al as well as Ni.

The utilized organic binder may be one that is known in the art. For example, the organic binder may utilize, but not limited to, a binder such as a cellulose-based resin, an epoxy-based resin, an aryl resin, an acryl resin, a phenol-formaldehyde resin, an unsaturated polyester resin, a polycarbonate resin, a polyamide resin, a polyimide resin, an alkyde resin, a rosin ester or the like.

The utilized organic solvent may also be one that is known in the art. For example, the organic solvent may utilize, but not limited to, a solvent such as butyl carbitol, butyl carbitol acetate, turpentine, α-terpineol, ethyl cellosolve, butyl phthalate or the like.

Thereafter, the ceramic green sheets provided with the first and second internal electrode patterns are laminated and pressurized in the lamination direction. Thus, the laminated ceramic green sheets and the internal electrode paste are pressed with each other. In such a manner, a ceramic laminate, including the alternately laminated ceramic green sheets and internal electrode paste, is manufactured.

Subsequently, the ceramic laminate is cut into chips in units of one capacitor. At this time, the cutting is performed such that the ends of the first and second internal electrodes are alternately and respectively exposed to the side surfaces thereof. The resultant laminate chip is fired at a temperature of approximately 1200° C. for example, thereby manufacturing a sintered ceramic body.

Thereafter, an external electrode paste is applied to the side surfaces of the sintered ceramic body so as to be electrically connected with the first and second internal electrodes respectively exposed to the side surfaces of the sintered ceramic body. Subsequently, a firing process is performed thereupon to thereby form first and second external electrodes.

The external electrode paste for the formation of the first and second external electrodes is a mixture of a conductive metal, an organic binder, an organic frit and an organic solvent.

The first and second external electrodes are formed by sintering a slurry, which is a mixture of a conductive metal, an organic binder, an organic frit and an organic solvent. The average pore size and porosity of the first and second external electrodes may be controlled by controlling the content and average particle size of the conductive metal, the kind and content of the organic binder, the content of the organic frit or the like.

The conductive metal may utilize copper, nickel, silver, or a mixture thereof. In addition, the conductive metal may have an average particle size of 0.1 μm to 3 μm, and the content thereof may range from 50% to 70%.

Furthermore, a kind of organic binder is not specifically limited, and the content thereof may range from 5% to 20%. The content of the organic frit may range from 5% to 30%.

Furthermore, the external electrode paste may be fired at a temperature of 600° C. to 900° C.

Also, a Ni plating layer (not shown) and a Sn plating layer may be formed on the first and second external electrodes by using a wet plating method.

The blister and warpage crack occurrence rates and the reliability of multilayer ceramic capacitors, manufactured under conditions disclosed in Table 1 below, were measured as follows.

TABLE 1

| | Porosity of | Average | | Warpage | |
|---|---|---|---|---|---|
| | external | pore | Blister | crack | |
| | electrode | size | occurrence | occurrence | |
| | (%) | (μm) | rate | rate | Reliability |
| Comparative | 16 | 7 | 0/30 | 0/30 | 8/40 |
| example 1 | | | | | |
| Comparative | 14 | 5 | 0/30 | 0/30 | 1/40 |
| example 2 | | | | | |
| Comparative | 12 | 5 | 0/30 | 0/30 | 1/40 |
| example 3 | | | | | |
| Inventive | 10 | 4 | 0/30 | 0/30 | 1/40 |
| example 1 | | | | | |
| Inventive | 6 | 3 | 0/30 | 0/30 | 0/40 |
| example 2 | | | | | |
| Inventive | 4 | 2 | 0/30 | 0/30 | 0/40 |
| example 3 | | | | | |
| Inventive | 4 | 3 | 0/30 | 0/30 | 0/40 |
| example 4 | | | | | |
| Inventive | 4 | 4 | 0/30 | 0/30 | 0/40 |
| example 5 | | | | | |
| Inventive | 2 | 2 | 0/30 | 0/30 | 0/40 |
| example 6 | | | | | |
| Inventive | 2 | 4 | 0/30 | 0/30 | 0/40 |
| example 7 | | | | | |
| Comparative | 1 | 2 | 0/30 | 1/30 | 0/40 |
| example 4 | | | | | |
| Comparative | 0 | 0 | 3/30 | 3/30 | 1/40 |
| example 5 | | | | | |

Referring to Table 1, comparative examples 1 to 3, in which an average pore size of an external electrode is 5 μm or greater and a porosity thereof is 12% or greater, show relatively low levels of reliability. Comparative example 4, having an average pore size of 2 μm and a porosity of 1%, causes warpage cracking. Comparative example 5, having an average pore size of 0 μm and a porosity of 100%, causes blisters and warpage cracking and shows a low level of reliability.

As set forth above, the multilayer ceramic capacitor, according to exemplary embodiments of the invention, includes first and second external electrodes containing a plurality of pores with an average pore size of 2 μm to 5 μm and having a porosity of 2% to 10%. Thus, the density of the external electrodes is controlled to thereby block the permeation of plating solution and moisture. This can prevent warpage cracking. Also, gas and binder components are effectively released at the time of firing the external electrodes, thereby lowering a blister occurrence rate.

While the present invention has been shown and described in connection with the exemplary embodiments, it will be apparent to those skilled in the art that modifications and variations can be made without departing from the spirit and scope of the invention as defined by the appended claims.

What is claimed is:

1. A multilayer ceramic capacitor comprising:
a sintered ceramic body;
a plurality of first internal electrodes and a plurality of second internal electrodes formed inside the sintered ceramic body, the first and second internal electrodes having ends alternately and respectively exposed to side surfaces of the sintered ceramic body; and
first and second external electrodes formed on the side surfaces of the sintered ceramic body and electrically connected to the first and second internal electrodes, the first and second external electrodes each including a plurality of pores with an average pore size of 2 μm to 5 μm and having a porosity of 2% to 10%.

2. The multilayer ceramic capacitor of claim 1, wherein the first and second external electrodes include a conductive metal having an average particle size of 0.1 μm to 3 μm.

3. The multilayer ceramic capacitor of claim 1, wherein the first and second external electrodes include at least one conductive metal selected from the group consisting of copper, nickel and silver.

4. The multilayer ceramic capacitor of claim 1, further comprising:
a nickel plating layer formed on the first and second external electrodes; and
a tin plating layer formed on the nickel plating layer.
